(19) United States
(12) Patent Application Publication
(10) Pub. No.: US 2026/0200331 A1
(43) Pub. Date: Jul. 16, 2026

(54) DEVICE AND METHOD FOR CONTROLLING A BRAKING TORQUE, AND AN AT LEAST PARTIALLY ELECTRICALLY DRIVEN VEHICLE

(71) Applicant: Robert Bosch GmbH, Stuttgart (DE)

(72) Inventor: Abel Eckart, Leingarten (DE)

(21) Appl. No.: 19/138,140

(22) PCT Filed: Feb. 16, 2024
(86) PCT No.: PCT/EP2024/053988

§ 371 Date: Jun. 12, 2025

(30) Foreign Application Priority Data
Feb. 20, 2023 (DE) 10 2023 201 428.9

(51) Int. Cl. B60L 7/18

(52) U.S. Cl. CPC B60L 7/18; B60L 2240/12; B60L 2240/461

(57) ABSTRACT

Regenerative deceleration of an at least partially electrically driven vehicle. It is provided that a minimum rotational speed for the wheels at which the regenerative deceleration is to be carried out is ascertained from parameters such as the vehicle speed and the friction coefficient between tires and road surface. The regenerative deceleration of the vehicle is set on the basis of this minimum rotational speed.

### FIELD

The present invention relates to a device and a method for controlling a braking torque, in particular a braking torque for regenerative deceleration. The present invention further relates to an at least partially electrically driven vehicle with such a device.

### BACKGROUND INFORMATION

Vehicles that are fully or at least partially electrically driven are becoming increasingly important. Such vehicles have an electric drive system that can drive the vehicle by means of electrical energy from a traction battery. In addition, this electric drive system can also be operated in a generator mode. In this case, the kinetic energy of the vehicle is converted into electrical energy by means of an electric machine. This electrical energy can be used to charge the traction battery of the vehicle.

Common braking strategies for electric vehicles provide that the braking torque generated by the electric motor is limited. For example, German Patent Application No. DE 10 2012 217 679 A1 describes a braking torque generated by an electric machine and applied to a rear axle of the vehicle is limited in such a way that the slip present at the wheels of the rear axle does not exceed a predetermined limit value.

### SUMMARY

The present invention provides, among other things, a device for controlling a braking torque and an at least partially electrically driven vehicle. Advantageous example embodiments of the present invention are disclosed herein.

Accordingly, the following is provided according to an example embodiment of the present invention:

A device for controlling a braking torque of an at least partially electrically driven vehicle comprising at least a first processing module and a second processing module as well as a control unit. The first processing module is designed to ascertain the actual speed of the vehicle. The second processing module is designed to ascertain a friction coefficient between a road surface and tires of the vehicle. The control unit is designed to ascertain a minimum rotational speed for wheels of an axle of the vehicle. In particular, the control unit can determine the minimum rotational speed for the wheels of an axle by using the ascertained actual speed and the ascertained friction coefficient. Furthermore, the control unit is designed to issue a request for regenerative deceleration of the vehicle. The request can be issued by using the ascertained minimum rotational speed for the wheels of the axle.

Furthermore, the following is provided according to an example embodiment of the present invention:

An at least partially electrically driven vehicle comprising an electric drive system and a device according to the present invention for controlling the braking torque.

Also, the following is provided according to an example embodiment of the present invention:

A method for controlling a regenerative braking torque for an at least partially electrically driven vehicle, comprising a step of ascertaining an actual speed of the vehicle and a step of ascertaining a friction coefficient between a road surface and tires of the vehicle. Furthermore, the method comprises a step of determining a minimum rotational speed for wheels of an axle of the vehicle. In particular, the minimum rotational speed for the wheels of the axle can be determined by using the ascertained actual speed and the friction coefficient. Furthermore, the method comprises a step of regeneratively decelerating the vehicle, wherein the deceleration of the vehicle is carried out by using the ascertained minimum rotational speed for the wheels of the axle.

The present invention is based on the finding that the electric drive system of an at least partially electrically driven vehicle can also be used to decelerate the vehicle. However, conventional operating strategies for decelerating the vehicle limit the maximum regenerative braking torque in order to ensure vehicle stability during the braking process. Especially in the case of higher braking requests, a large portion of the braking torque must therefore still be realized via mechanical, in particular hydraulic, brake components.

It is therefore an idea of the present invention to create a concept which can realize the largest possible portion of the required braking torque via regenerative deceleration by means of the electric drive system. For this purpose, an example embodiment of the present invention provides for ascertaining stability-relevant parameters, such as a friction coefficient between tires and road surface, and for determining therefrom a suitable value for the slip, i.e., a difference between wheel speeds and vehicle speed. In this way, the maximum braking torque for the regenerative deceleration of the vehicle can be increased without compromising the driving stability during the braking process.

For example, according to an example embodiment of the present invention, a current actual speed of the vehicle can be ascertained by using the sensors in the vehicle or information from the control components of the vehicle. Furthermore, for example, a friction coefficient between the tires of the vehicle and the road surface can be determined from monitoring the slip. This ascertainment of the friction coefficient can be derived, for example, during the driving of the vehicle from the comparison of the actual vehicle speed with the current wheel speed. In principle, however, any other approaches to ascertaining the slip or the friction coefficient are also possible.

From the current friction coefficient between road surface and tires of the vehicle and the current vehicle speed, a maximum acceptable slip of the wheels and thus a minimum permissible rotational speed of the wheels during braking can then be determined. The deceleration of the vehicle can then be controlled by means of regenerative braking on a drive axle in such a way that this minimum rotational speed is not undercut. This ensures vehicle stability even during regenerative braking.

According to an example embodiment of the present invention, if the required or requested braking torque is greater than the maximum braking torque that can be achieved by such a regenerative braking process, the remaining required braking torque can be realized on another axle, for example by a mechanical or hydraulic braking system. In this way, safe and stable deceleration of the vehicle with maximum regenerative braking power is possible.

According to an example embodiment of the present invention, the device for controlling the braking torque comprises a third processing module. This third processing module is designed to ascertain a side slip angle of the vehicle. In this case, the control unit can be designed to determine the minimum rotational speed for wheels of an axle of the vehicle by using the ascertained side slip angle as well. In this way, impairments due to a side slip of the vehicle, i.e., a movement vector of the vehicle that deviates from the running direction of the wheels, can also be taken into account. This can further increase the stability during the braking process.

According to an example embodiment of the present invention, the control unit is designed to receive a request for a braking torque to be set. Furthermore, the control unit can be designed to set a distribution of the braking torques on the axles of the vehicle by using the ascertained friction coefficient. For example, the braking torques on the individual axles of the vehicle can be set in such a way that the conditions for the minimum rotational speed of the wheels during regenerative braking are met according to the ascertained friction coefficient.

According to an example embodiment of the present invention, the control unit is designed to determine a maximum braking torque for one of the axles of the vehicle by using the ascertained friction coefficient. In particular, this maximum braking torque can be ascertained for the drive axle that is to be braked by means of regenerative braking according to the ascertained minimum rotational speed for the wheels of this axle. Furthermore, in this case, the control unit can be designed to determine a distribution for the braking torque on the axles of the vehicle by using the maximum braking torque for this axle of the vehicle. In other words, the braking power is distributed to the individual axles in such a way that the ascertained maximum braking torque for regenerative braking on the corresponding axle is not exceeded.

According to an example embodiment of the present invention, the control unit is designed to determine the maximum braking torque for one of the axles of the vehicle by using a maximum possible regenerative braking power. The maximum possible regenerative braking power can be limited, for example, by the maximum power of the electric machine on this axle. Furthermore, for example, a high state of charge or an operating temperature of the traction battery can also limit the maximum charging power of the traction battery and thus the maximum electrical braking power. Accordingly, such boundary conditions can also be included in the distribution of the braking power.

According to an example embodiment of the present invention, on one axle of the vehicle for which the maximum braking torque has been determined, the control unit sets a braking torque that does not exceed this maximum braking torque. Furthermore, the control unit can set the remaining portion of the requested braking torque on another axle of the vehicle. For example, the portion of the requested braking torque that cannot be achieved by regenerative braking on one axle can be implemented by a mechanical or hydraulic brake on another axle.

According to an example embodiment of the present invention, the second processing module is designed to determine a slip between a wheel of the vehicle and the road surface. Accordingly, the second processing module can ascertain the friction coefficient by using this slip. The slip can be ascertained, for example, from a difference between the current actual speed of the vehicle and the current wheel speed.

The above embodiments and developments can be combined with one another in any manner insofar as is reasonable. Further embodiments, developments, and implementations of the present invention also include combinations, even those not explicitly mentioned, of features of the present invention described above or in the following with regard to the exemplary embodiments. A person skilled in the art will in particular also add individual aspects as improvements or additions to the respective basic forms of the present invention.

### BRIEF DESCRIPTION OF THE DRAWINGS

Further features and advantages of the present invention will be explained in the following with reference to the figures.

FIG. 1 is a schematic diagram of a vehicle with a device for controlling the braking torque according to an example embodiment of the present invention.

FIG. 2 is a schematic representation of a block diagram of a device for controlling a braking torque according to an example embodiment of the present invention.

FIG. 3 is a flow chart on which a method for controlling a braking torque according to an example embodiment of the present invention is based.

### DETAILED DESCRIPTION OF EXAMPLE EMBODIMENTS

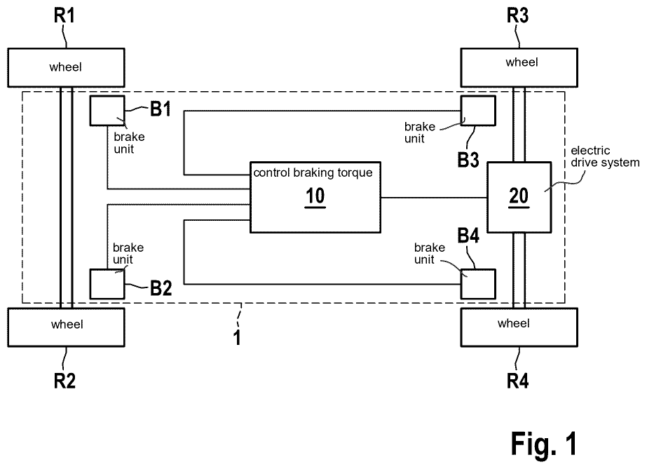

FIG. 1 shows a schematic diagram of a vehicle, in particular an at least partially electrically driven vehicle 1 according to an embodiment. The vehicle 1 comprises four wheels R1 to R4. Here, two wheels R1, R2 are arranged on a first axle A1 and two further wheels R3, R4 are arranged on a second axle A2. For example, the first axle A1 can be the front axle of a vehicle 1 and the second axle can be the rear axle of the vehicle 1. In principle, however, a reverse arrangement is also possible.

A brake unit B1, B2, B3, B4 is provided on each wheel R1, R2, R3, R4. These brake units B1, B2, B3, B4 may, for example, be hydraulic or electromechanical brake units.

Furthermore, the vehicle 1 comprises an electric drive system 20. This electric drive system 20 may, for example, comprise an electric machine, a power converter, and an electrical energy source, such as a traction battery. For driving the vehicle 1, the power converter can convert a direct current voltage from the traction battery into a single-phase or multi-phase alternating voltage and provide said alternating voltage to the electric machine.

Furthermore, the electric machine can convert kinetic energy of the vehicle into electrical energy, which can be converted into a direct current voltage by means of the power converter in order to charge the traction battery. This process is called regenerative braking.

The vehicle 1 further comprises a device 10 for controlling the braking torque, in particular for controlling the regenerative braking of the vehicle. As explained in more detail below, the device 10 for controlling the braking torque can process multiple parameters for this purpose and can control the regenerative braking on the basis thereof. In this way, it can be achieved that, on the one hand, vehicle stability is maintained during regenerative braking and, on the other hand, the highest possible portion of the kinetic energy of the vehicle can be converted into electrical energy.

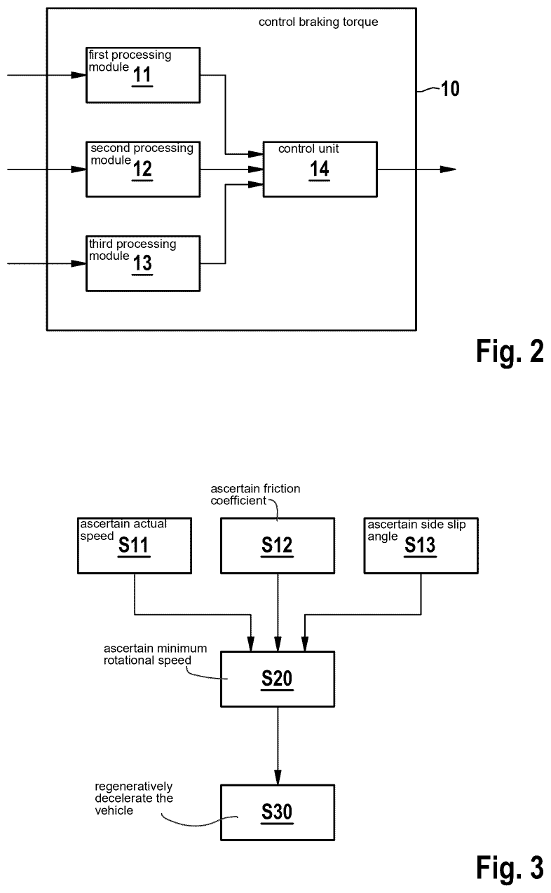

FIG. 2 shows a schematic diagram of a device 10 for controlling the braking torque according to an embodiment. The device 10 may, for example, comprise a first processing module 11, which is designed to ascertain a current actual speed of the vehicle 1. For this purpose, the first processing module 11 can, for example, receive sensor values from sensors in the vehicle 1 and/or obtain information from one or more control modules in the vehicle.

Furthermore, the device 10 for controlling the braking torque may comprise a second processing module 12, which is designed to ascertain a friction coefficient between the tires of the vehicle and the road surface thereunder. For example, a current slip of the wheels of the vehicle can be evaluated for this purpose. For example, the current wheel speed, i.e., the speed on an outer surface of the tire that comes into contact with the road surface, can be compared with the current actual speed of the vehicle 1. If necessary, a current drive torque on the corresponding wheel can also be taken into account in ascertaining the current friction coefficient. In addition, any other suitable parameters can of course also be considered in ascertaining the friction coefficient.

Furthermore, the device 10 for controlling the braking torque may comprise a third processing module 13, which ascertains a side slip angle of the vehicle. Any suitable vehicle parameters, sensor values, control data, etc., can also be evaluated for this purpose. The side slip angle can be considered to be a deviation between a movement vector of the vehicle 1 and the orientation of the vehicle 1 or the direction of travel according to the orientation of the wheels.

The data ascertained by the processing modules 11, 12, 13 on actual speed, friction coefficient, and side slip angle can be provided to a control unit 14. From these data, the control unit 14 can ascertain a maximum permissible slip for the wheels or a corresponding minimum rotational speed of the wheels during braking. For example, for each of the above-described parameters such as actual speed, friction coefficient, side slip angle, and possibly other parameters, a tabular or functional relationship can be specified, from which the permissible maximum slip or the minimum rotational speed of the wheels during braking can be derived. The corresponding data can be stored in the form of lookup tables, parameters for mathematical equations, or in any other suitable manner in a memory of the corresponding processing modules 11, 12, 13 or of the control unit 14.

The regenerative braking/deceleration of the vehicle 1 can then be controlled on the basis of this minimum rotational speed of the wheels. In doing so, a maximum braking torque that does not violate the requirements regarding the minimum rotational speed of the wheels can be set on an axle A2 of the vehicle that is coupled to the electric drive system 10.

If necessary, further boundary conditions can also be considered. For example, the maximum braking torque by the electric drive system may also be limited by properties such as the maximum power of the electric machine and/or of the electric power converter. In addition, properties of the traction battery that is charged during regenerative braking can also limit the maximum regenerative braking power. For example, the maximum charging power of the traction battery may be limited if the traction battery has a high state of charge or if the operating temperatures of the traction battery are very high or very low. Of course, other operating conditions that limit the maximum regenerative charging power can also be taken into account.

If the vehicle 1 is to be decelerated with a braking torque that is greater than the maximum braking power that can be achieved by regenerative braking according to the boundary conditions described above, the vehicle 1 can also be braked additionally by means of the brake elements B1, B2, B3, B4. In addition, the brake elements B1, B2, B3, B4 can also be used to be able to continue to maintain driving stability during deceleration of the vehicle 1. For this purpose, conventional stability systems such as ABS, ESP, etc., can be used, for example.

If the requested braking torque cannot be fully applied on one axle A2 due to regenerative braking on the basis of the specifications described above, a braking torque can be set on the other axle A1, for example, so that the requested braking torque is fully achieved in total.

Where appropriate, a user can be informed about the distribution of the braking torques between regenerative braking and mechanical braking during deceleration of the vehicle. For example, a user can be signaled when the required braking torque cannot be fully achieved by regenerative braking. In this way, the user can then adjust their driving behavior, where appropriate, in order to increase efficiency by using the highest possible regenerative braking portion.

FIG. 3 shows a flow chart on which a method for controlling a regenerative braking torque according to an embodiment is based. The method can in principle comprise any steps as already described in connection with the device 10 for controlling the braking torque. Analogously, the above-described device 10 for controlling the braking torque may also comprise any components required for implementing the method described below.

In a step S11, the actual speed of the vehicle 1 can be ascertained.

In step S12, a friction coefficient between road surface and tires of the vehicle 1 can then be ascertained.

In step S13, a side slip angle of the vehicle 1 can optionally be ascertained.

In step S20, a minimum rotational speed for the wheels R3, R4 of an axle A2 of the vehicle 1 is ascertained. The minimum rotational speed can be determined in particular using the ascertained actual speed and the friction coefficient, as well as, where appropriate, the side slip angle of the vehicle 1.

Finally, in step S30, the vehicle 1 is regeneratively decelerated using the ascertained minimum rotational speed for the wheels R3, R4 of the axle A2.

If the full required braking torque cannot be achieved by regenerative deceleration of the vehicle 1, the remaining portion of the requested braking torque can be achieved by braking the wheels R1, R2 on another axle A1 of the vehicle.

In summary, the present invention relates to regenerative deceleration of an at least partially electrically driven vehicle. For this purpose, it is provided that a minimum rotational speed for the wheels at which the regenerative deceleration is to be carried out is ascertained from parameters such as the vehicle speed and the friction coefficient between tires and road surface. The regenerative deceleration of the vehicle can subsequently be set on the basis of this minimum rotational speed.

1-10. (canceled)

11. A device for controlling a braking torque of an at least partially electrically driven vehicle, comprising:
a first processing module configured to ascertain an actual speed of the vehicle;
a second processing module configured to ascertain a friction coefficient between a road surface and tires of the vehicle; and
a control unit configured to determine a minimum rotational speed for wheels of an axle of the vehicle by using the ascertained actual speed and the ascertained friction coefficient, and to issue a request for regenerative deceleration of the vehicle by using the ascertained minimum rotational speed for the wheels of the axle.

12. The device according to claim 11, further comprising:
a third processing module configured to ascertain a side slip angle of the vehicle;
wherein the control unit is configured to determine the minimum rotational speed for the wheels of the axle of the vehicle by also using the ascertained side slip angle.

13. The device according to claim 11, wherein the control unit is configured to receive a request for a braking torque to be set, and to set a distribution of the braking torques on multiple axles of the vehicle by using the ascertained friction coefficient.

14. The device according to claim 13, wherein the vehicle includes multiple axles, and the control unit is configured to determine a maximum braking torque for one of the axles of the vehicle by using the ascertained friction coefficient, and to determine a distribution for the braking torque on the multiple axles of the vehicle by using the maximum braking torque on the one of the axles of the vehicle.

15. The device according to claim 14, wherein the control unit is configured to determine the maximum braking torque for the one of the axles of the vehicle by using a maximum possible regenerative braking power.

16. The device according to claim 14, wherein a braking torque that does not exceed the maximum braking torque is set on the one of the axles of the vehicle for which the maximum braking torque has been determined, and a remaining portion of the requested braking torque is set on another axle of the axles of the vehicle.

17. The device according to claim 11, wherein the second processing module is configured to determine a slip between a wheel of the vehicle and the road surface and to ascertain the friction coefficient by using the slip.

18. An electrically driven vehicle, comprising:
an electric drive system; and
a device configured to control a braking torque of the vehicle, including:
a first processing module configured to ascertain an actual speed of the vehicle,
a second processing module configured to ascertain a friction coefficient between a road surface and tires of the vehicle, and
a control unit configured to determine a minimum rotational speed for wheels of an axle of the vehicle by using the ascertained actual speed and the ascertained friction coefficient, and to issue a request for regenerative deceleration of the vehicle by using the ascertained minimum rotational speed for the wheels of the axle.

19. A method for controlling a regenerative braking torque for an at least partially electrically driven vehicle, comprising the following steps:
ascertaining an actual speed of the vehicle;
ascertaining a friction coefficient between a road surface and tires of the vehicle;
determining a minimum rotational speed for wheels of an axle of the vehicle by using the ascertained actual speed and the friction coefficient; and
regeneratively decelerating the vehicle by using the ascertained minimum rotational speed for the wheels of the axle.

20. The method according to claim 19, further comprising:
ascertaining a side slip angle of the vehicle;
wherein the minimum rotational speed for the wheels is determined by also using the ascertained side slip angle.
